(19) United States
(12) Patent Application Publication
(10) Pub. No.: US 2004/0020447 A1
(43) Pub. Date: Feb. 5, 2004

(54) Method and apparatus for advancing air into a fuel reformer by use of an engine vacuum

(76) Inventors: William Taylor III, Columbus, IN (US); Rodney H. Cain, Swartz Creek, MI (US); Donald T. Carbone, Troy, MI (US)

Correspondence Address: BARNES & THORNBURG, 11 SOUTH MERIDIAN, INDIANAPOLIS, IN, 46204

(21) Appl. No.: 10/612,312

(22) Filed: Jul. 2, 2003

Related U.S. Application Data
(60) Provisional application No. 60/401,092, filed on Aug. 5, 2002.

(51) Int. Cl. F02B 51/00; F01N 3/36

(52) U.S. Cl. 123/3; 60/303

(57) ABSTRACT

A method of operating a power system is includes operating an internal combustion engine so as to produce an engine vacuum, and advancing air into a fuel reformer with the engine vacuum. The method also includes advancing reformate gas produced by the fuel reformer to a component such as the intake of the engine, an emission abatement device, or a fuel cell. A power system operated by such a method is also disclosed.

This application claims priority to U.S. Provisional Patent Application Serial No. 60/401,092 which was filed on Aug. 5, 2002, the disclosure of which is hereby incorporated by reference.

### CROSS REFERENCE TO RELATED APPLICATIONS

Cross reference is made to copending U.S. patent application Ser. No. ______ (Attorney Docket No. 9501-72760) entitled “Method and Apparatus for Generating Pressurized Air by Use of Reformate Gas from a Fuel Reformer,” along with copending U.S. patent application Ser. No. ______ (Attorney Docket No. 9501-72886) entitled “Method and Apparatus for Advancing Air into a Fuel Reformer by Use of a Turbocharger,” both of which are assigned to the same assignee as the present application, filed concurrently herewith, and hereby incorporated by reference.

### FIELD OF THE DISCLOSURE

The present disclosure relates generally to a power system and a method of operating the power system. More particularly, the present disclosure relates to advancing air into a fuel reformer of the power system.

### BACKGROUND OF THE DISCLOSURE

A fuel reformer is used to reform a hydrocarbon fuel into a reformate gas. Some fuel reformers use a mixture of air and fuel to produce the reformate gas. More particularly, air is advanced into such fuel reformers and mix with fuel with such a mixture being used to produce the reformate gas.

Reformate gas from fuel reformers may be utilized as a fuel or fuel additive in the operation of an internal combustion engine. Such reformate gas may also be utilized to regenerate an emission abatement device or as a fuel for a fuel cell.

### SUMMARY OF THE DISCLOSURE

According to one aspect of the disclosure, a power system includes an internal combustion engine. An engine vacuum is present at the intake of the engine during operation thereof. A fuel reformer has an outlet fluidly coupled to the intake of the engine. The engine vacuum causes air to be advanced through the fuel reformer during operation of the engine.

A method of operating the above system includes operating the internal combustion engine so as to produce the engine vacuum, and advancing air through the fuel reformer with the engine vacuum.

The fuel reformer produces a reformate gas. The reformate gas is advanced to a component of the power system with the engine vacuum. For example, the reformate gas is advanced to one or more of the intake of the engine, an emission abatement device, and a fuel cell.

### BRIEF DESCRIPTION OF THE DRAWINGS

FIG. 1 is a simplified block diagram of a power system that uses the engine vacuum of an internal combustion engine to advance air into a fuel reformer and to advance a reformate gas produced by the fuel reformer to the engine;

FIG. 2 is a simplified block diagram of a second embodiment of a power system that uses the engine vacuum of an internal combustion engine to advance air into a fuel reformer and to advance a reformate gas produced by the fuel reformer to an emission abatement device;

FIG. 3 is a simplified block diagram of a third embodiment of a power system that uses the engine vacuum of an internal combustion engine to drive a turbocharger which, when driven, advances pressurized air into a fuel reformer to advance a reformate gas produced by the fuel reformer to an emission abatement device;

FIG. 4 is a simplified block diagram of a fourth embodiment of a power system in which exhaust gas discharged from an internal combustion engine drives a turbocharger which, when driven, advances pressurized air into a fuel reformer to advance a reformate gas produced by the fuel reformer to the engine;

FIG. 5 is a simplified block diagram of a fifth embodiment of a power system in which exhaust gas discharged from an internal combustion engine drives a turbocharger which, when driven, advances pressurized air into a fuel reformer to advance a reformate gas produced by the fuel reformer to an emission abatement device;

FIG. 6 is a simplified block diagram of a sixth embodiment of a power system having a turbocharger that advances pressurized air to a fuel reformer that produces a reformate gas that drives the turbocharger and advances to a component of the power system;

FIG. 7 is a simplified block diagram showing an internal combustion engine as being the component of the power system of FIG. 6 that receives the reformate gas produced by the fuel reformer;

FIG. 8 is a simplified block diagram showing an emission abatement device as being the component of the power system of FIG. 6 that receives the reformate gas produced by the fuel reformer; and

FIG. 9 is a simplified block diagram showing a fuel cell as being the component of the power system of FIG. 6 that receives the reformate gas produced by the fuel reformer.

### DETAILED DESCRIPTION OF ILLUSTRATIVE EMBODIMENTS

While the concepts of the present disclosure are susceptible to various modifications and alternative forms, specific exemplary embodiments thereof have been shown by way of example in the drawings and will herein be described in detail. It should be understood, however, that there is no intent to limit the disclosure to the particular forms disclosed, but on the contrary, the intention is to cover all modifications, equivalents, and alternatives following within the spirit and scope of the invention as defined by the appended claims.

Referring now to FIG. 1, there is shown a power system 10 which includes a fuel reformer 12 and an internal combustion engine 14. A conduit 16 interconnects the fuel reformer 12 and the engine 14. The fuel reformer 12 uses fuel and air to produce a reformate gas. The reformate gas is, for example, hydrogen-rich gas. The reformate gas may include other constituents such as carbon monoxide. The fuel is, for example, a hydrocarbon fuel, such as gasoline or diesel fuel, supplied by a fuel tank (not shown) of the power system 10.

The engine 14 produces an engine vacuum when running (i.e., operated in an actuated mode of operation). The engine vacuum is communicated from the engine 14 to the fuel reformer 12 via the conduit 16 so as to draw or otherwise advance air into the fuel reformer 12. At some point (either prior to or subsequent to entry into the fuel reformer 12), some portion of the air may be mixed with fuel with the resultant mixture being reformed so as to produce the reformate gas. The engine vacuum further draws or otherwise advances the reformate gas from the fuel reformer 12 into the engine 14 so as to enhance the combustion process in the engine 14, for example.

The fuel reformer 12 comprises, for example, a plasma fuel reformer. A plasma fuel reformer uses a plasma a heated, electrically conducting gas- to convert hydrocarbon fuel into hydrogen-rich gas. Such a plasma fuel reformer heats the electrically conducting gas either by an arc discharge or by a high frequency inductive or microwave discharge. Systems including plasma fuel reformers are disclosed in U.S. Pat. No. 5,425,332 issued to Rabinovich et al.; U.S. Pat. No. 5,437,250 issued to Rabinovich et al.; U.S. Pat. No. 5,409,784 issued to Bromberg et al.; and U.S. Pat. No. 5,887,554 issued to Cohn, et al., the disclosures of each of which is hereby incorporated by reference. Additional examples of systems including plasma fuel reformers are disclosed in copending U.S. patent application Ser. No. 10/158,615 entitled “Low Current Plasmatron Fuel Converter Having Enlarged Volume Discharges” which was filed on May 30, 2002 by A. Rabinovich, N. Alexeev, L. Bromberg, D. Cohn, and A. Samokhin, along with copending U.S. patent application Ser. No. 10/411,917 entitled “Plasmatron Fuel Converter Having Decoupled Air Flow Control” which was filed on Apr. 11, 2003 by A. Rabinovich, N. Alexeev, L. Bromberg, D. Cohn, and A. Samokhin, the disclosures of both of which are hereby incorporated by reference. The fuel reformer 12 may comprise another type of fuel reformer, such as a catalytic fuel reformer, a thermal fuel reformer, or a steam fuel reformer.

The fuel reformer 12 includes an air inlet 18 for admitting air into the fuel reformer 12 and a reformate gas outlet 20 for discharging the reformate gas from the fuel reformer 12. The engine 14 has an intake 22 such as an intake manifold for admitting the reformate gas into the engine 14. The conduit 16 is coupled to the reformate gas outlet 20 and the intake 22 to conduct the reformate gas from the outlet 20 to the intake 22.

During operation of the engine 14, the engine vacuum is present at intake 22. The engine vacuum causes air to advance through the inlet 18 and into the fuel reformer 12. The engine vacuum further causes the reformate gas produced by the reformer 12 to advance from the outlet 20 through the conduit 16 to the intake 22.

During advancement of air through the fuel reformer 12 with the engine vacuum, a pressure drop across the fuel reformer 12 from the inlet 18 to the outlet 20 is present. As such, an outlet pressure at the outlet 20 is less than an inlet pressure at the inlet 18.

Advancing the reformate gas from the outlet 20 through the conduit 16 to the intake 22 generates a pressure drop across the conduit 16 between the outlet 20 and the intake 22. More particularly, advancing the reformate gas from the outlet 20 through the conduit 16 to the intake 22 generates an intake pressure at the intake 22 which is less than the outlet pressure at the outlet 20.

Operation of the engine 14 produces mechanical output which is used to drive or otherwise mechanically power a driven mechanism (not shown). Specifically, the driven mechanism is mechanically coupled to an output mechanism of the engine 14 such as a crankshaft or the like. The driven mechanism may be embodied as a transmission, specifically a vehicle transmission, which is used to propel a vehicle. In the case of when the power system 10 is used in the construction of a stationary power-generating system or a hybrid vehicle, the driven mechanism may be provided as a power generator or the like for producing electrical power from the mechanical output of the engine 14. The driven mechanism may be embodied as any type of mechanism which is driven by an internal combustion engine. For example, the driven mechanism may be embodied as a pump mechanism or the like.

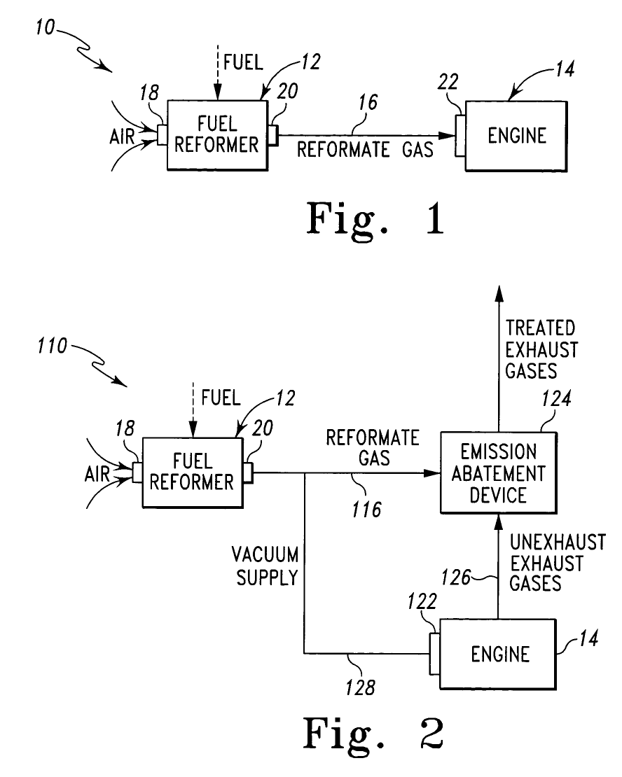

Referring now to FIG. 2, there is shown another power system 110. The power system 110 includes structures similar to structures of the power system 10 so that like reference numerals refer to like structures.

The power system 110 includes the fuel reformer 12 and the engine 14. The power system 110 further includes an emission abatement device 124 such as a NOₓ absorber or a soot filter. The emission abatement device 124 is fluidly coupled to the engine 14 via an exhaust gas conduit 126 to receive exhaust gas discharged from the engine 14 to remove or otherwise treat emissions of the exhaust gas.

The device 124 is arranged, for example, to remove compounds such as NOₓ, SOₓ, or soot particles present in the exhaust gas discharged from the engine 14. In particular, the device 124 may be used to trap or otherwise capture one or more compounds present in the engine's exhaust gases. In such a way, treated emissions are exhausted into the surrounding atmosphere.

The emission abatement device 124 is fluidly coupled to the reformate gas outlet 20 of the fuel reformer 12 via a reformate gas conduit 116 to receive the reformate gas from the fuel reformer 12. The reformate gas is used to regenerate or otherwise condition the emission abatement device 124 during operation of the engine 14.

The engine vacuum produced by the engine 14 is used to draw or otherwise advance the reformate gas from the outlet 20 to the emission abatement device 124. To do so, a vacuum source 122 of the engine 14 is fluidly coupled to the reformate gas conduit 116 via a vacuum supply conduit 128. The engine vacuum thus causes the reformate gas to advance from the outlet 20 of the fuel reformer 12 to the emission abatement device 124 via the reformate gas conduit 116. It should be appreciated that the vacuum present in the supply conduit 128 also causes air to be advanced into the fuel reformer 12 in a similar manner to as described above with respect to FIG. 1.

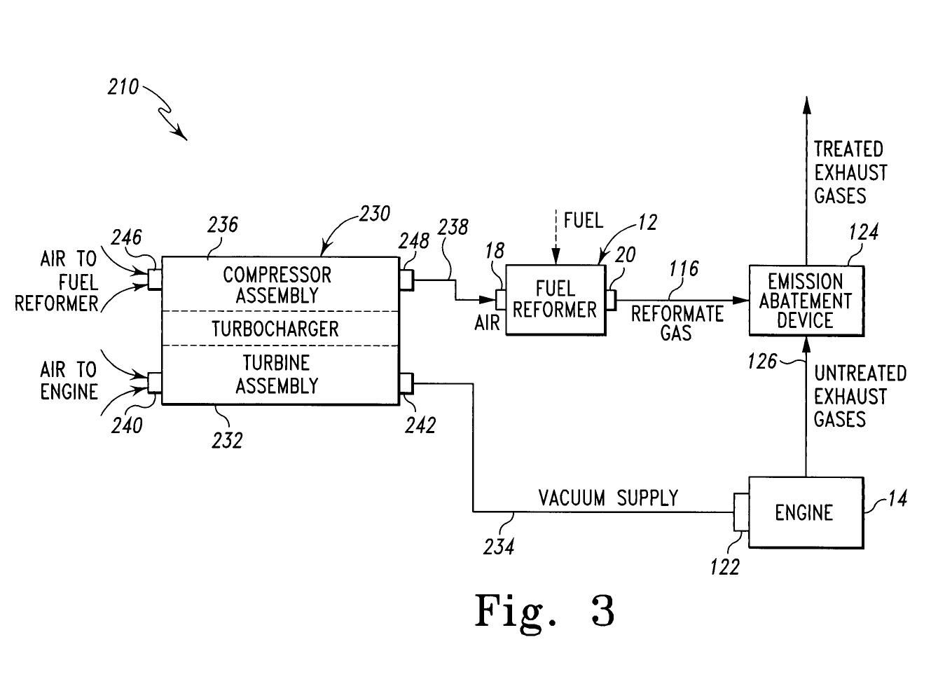

Referring now to FIG. 3, there is shown another power system 210. The power system 210 includes structures similar to structures of the power system 10 and the power system 110 so that like reference numerals refer to like structures.

Similar to power system 110, power system 210 includes an emission abatement device 124 fluidly coupled to a fuel reformer 12 via a reformate gas conduit 116. The emission abatement device 124 is fluidly coupled to an engine 14 via an exhaust gas conduit 126 to receive exhaust gas discharged from the engine 14 to reduce or otherwise treat emissions of the exhaust gas.

Power system 210 also includes a turbocharger 230 for advancing air into the inlet 18 of the fuel reformer 12 with the engine vacuum produced by the engine 14. In particular, the turbocharger 230 has a turbine assembly 232 and a compressor assembly 236. The turbine assembly 232 is driven by the engine vacuum. The turbine assembly 232 in turn drives the compressor assembly 236 via a shaft (not shown) coupled to the turbine assembly 232 and the compressor assembly 236. Operation of the compressor assembly 236 pressurizes air and advances the pressurized air into the fuel reformer 12. Operation of the compressor assembly 236 further causes the reformate gas produced by the fuel reformer 12 to advance from the fuel reformer 12 to the emission abatement device 124 for regeneration of the emission abatement device 124.

The turbine assembly 232 has a turbine gas inlet 240 and a turbine gas outlet 242. The turbine gas outlet 242 is fluidly coupled to a vacuum source 122 of the engine 14 via a vacuum supply conduit 234. The engine vacuum provided by the vacuum source 122 draws or otherwise advances air through the turbine gas inlet 240, the turbine assembly 232, the turbine gas outlet 242, and the vacuum supply conduit 234 to drive the turbine assembly 232.

The compressor assembly 236 has an unpressurized air inlet 246 and a pressurized air outlet 248. The unpressurized air inlet 246 admits unpressurized air (i.e., air having a pressure lower than air at the pressurized air outlet 248) into the compressor assembly 236. The pressurized air outlet 248 discharges air pressurized by the compressor assembly 236. The pressurized air outlet 248 is fluidly coupled to the inlet 18 of the fuel reformer 12 via a pressurized air conduit 238. Operation of the compressor assembly 238 causes pressurized air to advance from the pressurized air outlet 248 through the pressurized air conduit 238 and through the inlet 18 of the fuel reformer 12 and causes the reformate gas produced by the fuel reformer 12 to advance from the outlet 20 of the fuel reformer 12 through the reformate gas conduit 116 to the emission abatement device 124.

It should be appreciated that the herein described systems may also be utilized to supply reformate gas from the fuel reformer to components other than an engine or an emission abatement device. For example, the engine vacuum produced by the engine may be used to advance air into the fuel reformer and to advance a reformate gas produced by the fuel reformer from the fuel reformer to a fuel cell. A fuel cell uses the reformate gas to generate electricity to power electrical components of the power system or other electrical components. The fuel cell may be embodied as any type of fuel cell. For example, the fuel cell may be embodied as an alkaline fuel cell (AFC), a phosphoric acid fuel cell (PAFC), a proton exchange membrane fuel cell (PEMFC), a solid oxide fuel cell (SOFC), a molten carbonate fuel cell (MCFC), or any other type of fuel cell.

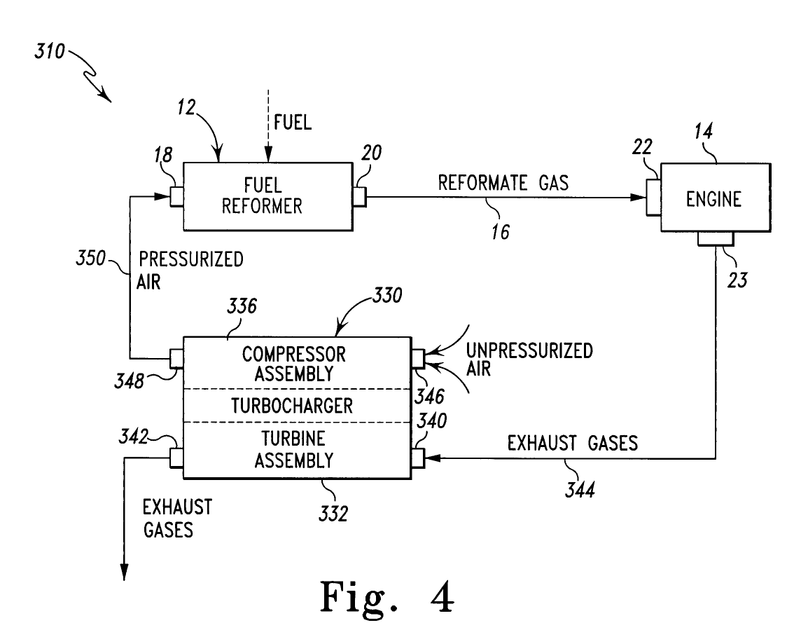

Referring now to FIG. 4, another power system 310 is shown. The power system 310 includes structures similar to structures of the above-described power systems so that like reference numerals refer to like structures.

The power system 310 includes a fuel reformer 12, an internal combustion engine 14, and a turbocharger 330. The fuel reformer 12 uses fuel from a fuel tank (not shown) and pressurized air from the turbocharger 330 to produce a reformate gas which is advanced to the engine 14. Exhaust gas discharged from the engine 14 is used to drive the turbocharger 330 so that the turbocharger 330 can provide the pressurized air for use by the fuel reformer 12.

The turbocharger 330 has a turbine assembly 332 and a compressor assembly 336 coupled to the turbine assembly 332 via a shaft (not shown). The turbine assembly 332 has a turbine gas inlet 340 and a turbine gas outlet 342. The turbine gas inlet 340 admits exhaust gas discharged from the exhaust manifold 23 of the engine 14 into the turbine assembly 332. The turbine gas outlet 342 discharges exhaust gas from the turbine assembly 332. The turbine gas inlet 340 is fluidly coupled to the exhaust manifold 23 of the engine 14 via an exhaust gas conduit 348 so that exhaust gas discharged from the exhaust manifold 23 flows from the exhaust manifold 23 through the exhaust gas conduit 344, the turbine gas inlet 340, the turbine assembly 332, and the turbine gas outlet 342 to drive the turbine assembly 332.

The compressor assembly 336 has an unpressurized air inlet 346 and a pressurized air outlet 348. The unpressurized air inlet 346 admits unpressurized air (i.e., air having a pressure lower than air at the pressurized air outlet 348) into the compressor assembly 336. The pressurized air outlet 348 discharges pressurized air from the compressor assembly 336.

The exhaust gas drives the turbine assembly 332 as it advances therethrough. The turbine assembly 332 in turn drives the compressor assembly 336. As the compressor assembly 336 is driven, it pressurizes unpressurized air admitted into the compressor assembly 336 through the unpressurized air inlet 346 to provide pressurized air at the pressurized air outlet 348. The pressurized air outlet 348 is fluidly coupled to the pressurized air inlet 18 of the fuel reformer via a pressurized air conduit 350. In such a way, pressurized air from the turbocharger 330 is advanced out the pressurized air outlet 348, through the pressurized air conduit 350, and into the pressurized air inlet 346. Operation of the turbocharger 330 thus advances pressurized air from the turbocharger 330 into the fuel reformer 12.

The fuel reformer uses the pressurized air and fuel to produce the reformate gas. The reformate gas is discharged from a reformate gas outlet 20 of the fuel reformer 12 and advances from the reformate gas outlet 20 through a reformate gas conduit 16 to an intake 22 of the engine 14 with the pressurized air. Operation of the turbocharger 330 thus also advances the reformate gas from the fuel reformer 12 to the engine 14.

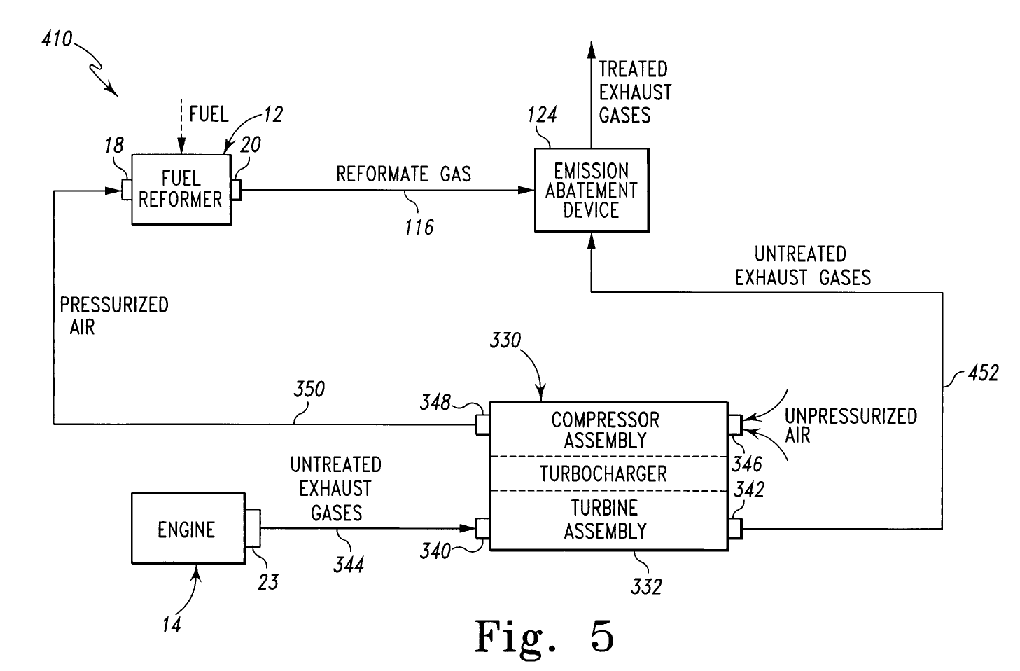

Referring now to FIG. 5, another power system 410 is shown. The power system 410 includes structures similar to structures of the above-described power systems so that like reference numerals refer to like structures.

The power system 410 includes a fuel reformer 12, an internal combustion engine 14, a turbocharger 330, and an emission abatement device 124. Exhaust gas discharged from the engine 14 flows through the turbocharger 330 to operate the turbocharger 330 and then flows through the emission abatement device 124 for treatment of the exhaust gas prior to discharge to the surrounding atmosphere. Operation of the turbocharger 330 pressurizes air and causes the pressurized air to advance into the fuel reformer 12. The reformate gas produced by the fuel reformer 12 is advanced from the fuel reformer 12 to the emission abatement device 124 by pressurized air from the turbocharger 330 for regeneration of the emission abatement device 124.

The turbocharger 330 is fluidly coupled to the engine 14, the emission abatement device 124, and the fuel reformer 12. The exhaust manifold 23 of the engine 14 is fluidly coupled to a turbine gas inlet 340 of a turbine assembly 332 of the turbocharger 330 via an exhaust gas conduit 344. In such a way, exhaust gas from the exhaust manifold 23 is advanced through the exhaust gas conduit 344 an into the turbine gas inlet 340. A turbine gas outlet 342 is fluidly coupled to the emission abatement device 124 via an exhaust gas conduit 452 to provide exhaust gas from the turbine gas outlet 342 through the exhaust gas conduit 452 to the emission abatement device 124. A pressurized air outlet 348 of a compressor assembly 336 of the turbocharger 330 is fluidly coupled to a pressurized air inlet 18 of the fuel reformer 12 via a pressurized air conduit 350 to provide pressurized air from the pressurized air outlet 348 through the pressurized air conduit 350 to the pressurized air inlet 18.

Exhaust gas drives the turbine assembly 332 as it flows from the turbine gas inlet 340 through the turbine assembly 332 to the turbine gas outlet 342. The turbine assembly 332 in turn drives the compressor assembly 336. Operation of the compressor assembly 336 pressurizes air that enters the compressor assembly 336 through an unpressurized air inlet 346 and exits the compressor assembly 336 through the pressurized air outlet 348. The driven compressor assembly 336 causes the pressurized air to advance through the pressurized air conduit 350 and the pressurized air inlet 18 into the fuel reformer 12 and causes the reformate gas produced by the fuel reformer 12 to advance from a reformate gas outlet 20 of the fuel reformer 12 to the emission abatement device 12 through a reformate gas conduit 116.

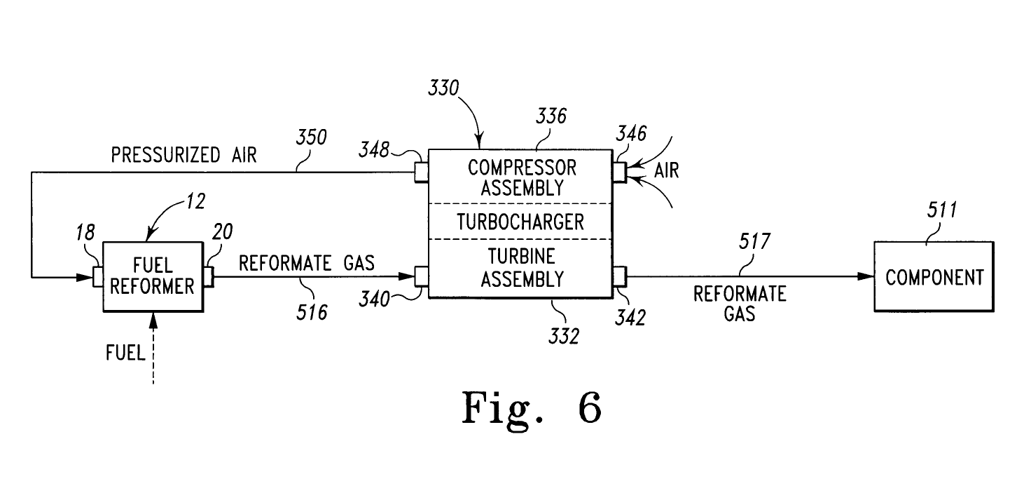

Referring now to FIG. 6, another power system 510 is shown. The power system 510 includes structures similar to structures of the above-described power systems so that like reference numerals refer to like structures.

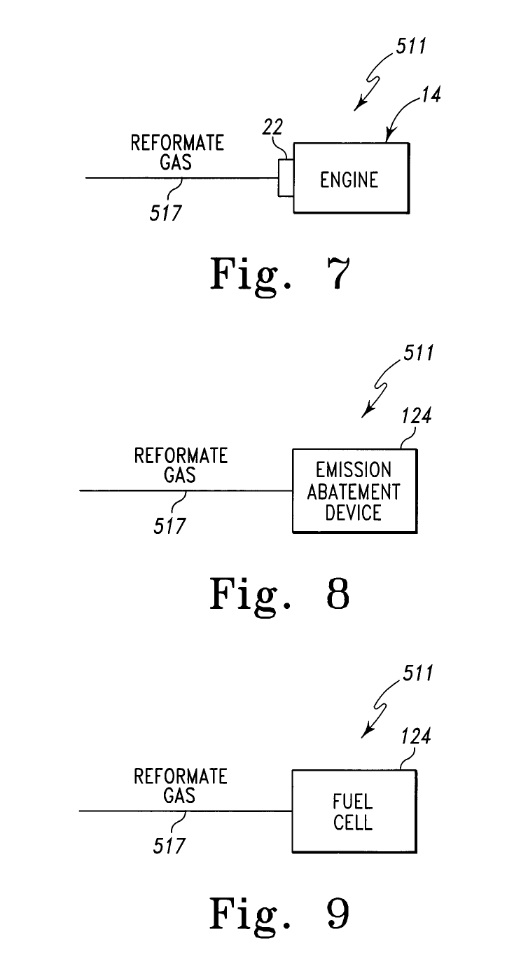

The power system 510 includes a fuel reformer 12, a turbocharger 330, and a component 511. The component 511 may be, for example, the internal combustion engine 14 (see FIG. 7), the emission abatement device 124 (see FIG. 8), or a fuel cell 513 (see FIG. 9). The reformate gas produced by the fuel reformer 12 advances through the turbocharger 330 to operate the turbocharger 330. Thereafter, the reformate gas is exhausted from the turbocharger 330 and advanced to either the intake 22 of the engine 14, the emission abatement device 124, or the fuel cell 513. Hence, operation of the turbocharger 330 provides pressurized air for input into the fuel reformer 12, and, similar to as described above, for advancement of the reformate gas produced from the fuel reformer 12 to the component 511 (via the turbocharger 330).

The turbocharger 330 is fluidly coupled to the fuel reformer 12 and the component 511. In particular, the turbine gas inlet 340 of a turbine assembly 332 of the turbocharger 330 is fluidly coupled to the reformate gas outlet 20 of the fuel reformer 12 via a reformate gas conduit 516. The turbine gas outlet 342 of the turbine assembly 332 is fluidly coupled to the component 511 via a reformate gas conduit 517. The pressurized air outlet 348 is fluidly coupled to a pressurized air inlet 18 of the fuel reformer via a pressurized air conduit 350.

The reformate gas produced by the fuel reformer 12 drives the turbine assembly 332. The reformate gas advances from the reformate gas outlet 20 through the reformate gas conduit 516 to the reformate gas inlet 340 of the turbine assembly 332. The reformate gas then flows from the reformate gas inlet 340 through the turbine assembly 332 to the reformate gas outlet 342 of the turbine assembly 332 to drive the turbine assembly 332. Upon exiting the turbine assembly 332 through the reformate gas outlet 342, the reformate gas advances through the reformate gas conduit 517 to the component 511.

Flow of exhaust gas through the turbine assembly 332 causes the turbine assembly 332 to drive the compressor assembly 336. Operation of the compressor assembly 336 causes unpressurized air to enter the compressor assembly 336 through an unpressurized air inlet 346, to flow through the compressor assembly 336, and to exit the compressor assembly 336 through the pressurized air outlet 348 as pressurized air. Upon exiting the compressor assembly 336, the pressurized air advances through the pressurized air conduit 350 to the pressurized air inlet 18 of the fuel reformer 12 for mixing with fuel to produce the reformate gas.

While the concepts of the present disclosure have been illustrated and described in detail in the drawings and foregoing description, such an illustration and description is to be considered as exemplary and not restrictive in character, it being understood that only the illustrative embodiments have been shown and described and that all changes and modifications that come within the spirit of the disclosure are desired to be protected.

There are a plurality of advantages of the concepts of the present disclosure arising from the various features of the systems described herein. It will be noted that alternative embodiments of each of the systems of the present disclosure may not include all of the features described yet still benefit from at least some of the advantages of such features. Those of ordinary skill in the art may readily devise their own implementations of a system that incorporate one or more of the features of the present disclosure and fall within the spirit and scope of the invention as defined by the appended claims.

1. A method of operating a power system, the method comprising the steps of:
operating an internal combustion engine so as to produce an engine vacuum, and
advancing air through a fuel reformer with the engine vacuum.

2. The method of claim 1, further comprising the step of advancing a reformate gas produced by the fuel reformer to an intake of the engine with the engine vacuum.

3. The method of claim 2, further comprising the step of advancing the reformate gas produced by the fuel reformer to an emission abatement device.

4. The method of claim 2, wherein:
the reformate gas comprises a hydrogen-rich gas, and
the reformate gas advancing step comprises advancing the hydrogen-rich gas to the intake of the engine with the engine vacuum.

5. The method of claim 1, further comprising the step of advancing a reformate gas produced by the fuel reformer to an emission abatement device.

6. The method of claim 1, wherein:
the fuel reformer has an inlet and an outlet, and
the advancing step comprises generating a pressure drop across the fuel reformer from the inlet to the outlet with the engine vacuum.

7. The method of claim 1, wherein:
the fuel reformer comprises a plasma fuel reformer having an air inlet and a reformate gas outlet, and
the advancing step comprises generating an outlet pressure at the reformate gas outlet which is less than an inlet pressure at the air inlet.

8. The method of claim 1, wherein the fuel reformer comprises a plasma fuel reformer having a gas outlet, further comprising the step of advancing a reformate gas produced by the plasma fuel reformer from the gas outlet to an intake of the engine with the engine vacuum.

9. The method of claim 8, wherein:
the reformate gas comprises a hydrogen-rich gas, and
the reformate gas advancing step comprises advancing the hydrogen-rich gas from the gas outlet of the plasma fuel reformer to the intake of the engine with the engine vacuum.

10. The method of claim 1, wherein the advancing step comprises operating a turbocharger with the engine vacuum to advance air through the fuel reformer.

11. The method of claim 10, further comprising advancing a reformate gas produced by the fuel reformer to an emission abatement device.

12. A power system, comprising:
an internal combustion engine having an intake, wherein (i) the engine is operable in an actuated mode of operation, and (ii) an engine vacuum is present at the intake when the engine is operated in the actuated mode of operation, and
a fuel reformer having an outlet fluidly coupled to the intake, wherein the engine vacuum causes air to be advanced through the fuel reformer when the engine is operated in the actuated mode of operation.

13. The power system of claim 12, wherein the engine vacuum further causes reformate gas from the fuel reformer to be advanced from the outlet of the fuel reformer to the intake of the engine when the engine is operated in the actuated mode of operation.

14. The power system of claim 13, wherein the reformate gas comprises hydrogen.

15. The power system of claim 12, wherein:
the fuel reformer has an inlet, and
the engine vacuum generates a pressure drop across the fuel reformer from the inlet to the outlet when the engine is operated in the actuated mode of operation.

16. The power system of claim 12, wherein the fuel reformer comprises a plasma fuel reformer.

17. A method of operating a power system, the method comprising the steps of:
operating an internal combustion engine so as to produce an engine vacuum, and
advancing reformate gas from a fuel reformer to an intake of the engine with the engine vacuum.

18. The method of claim 17, wherein:
the fuel reformer has an outlet, and
the advancing step comprises generating a pressure drop across a conduit from the outlet of the fuel reformer to the intake of the engine with the engine vacuum.

19. The method of claim 17, wherein:
the fuel reformer comprises a plasma fuel reformer having a reformate gas outlet, and
the advancing step comprises generating an intake pressure at the intake of the engine which is less than an outlet pressure at the reformate gas outlet.

20. The method of claim 17, wherein:
the reformate gas comprises a hydrogen-rich gas, and
the advancing step comprises advancing the hydrogen-rich gas to the intake of the engine with the engine vacuum.
